(19) United States
(12) Patent Application Publication
(10) Pub. No.: US 2018/0020349 A1
(43) Pub. Date: Jan. 18, 2018

(54) Electronic Device with Biometric Authentication Control of Companion Devices, and Corresponding Systems and Methods

(71) Applicant: Motorola Mobility LLC, Chicago, IL (US)

(72) Inventors: Vivek Tyagi, Chicago, IL (US); Sudhir Vissa, Bensenville, IL (US)

(21) Appl. No.: 15/209,524

(22) Filed: Jul. 13, 2016

(51) Int. Cl. H04W 12/06; H04L 29/06

(52) U.S. Cl. CPC H04W 12/06; H04L 63/083; H04L 63/0861

(57) ABSTRACT

An electronic device includes a biometric sensor, such as a fingerprint sensor, that identifies biometric input received at the biometric sensor. One or more processors operable with the biometric sensor identify at least one authentication agent operating on at least one companion device operating within a wireless communication radius of the electronic device. The processors then select an authentication credential for selected authentication agents. A wireless communication circuit delivers the authentication credential to the authentication agent. An authentication tool can also be delivered.

### BACKGROUND

### Technical Field

This disclosure relates generally to electronic devices, and more particularly to electronic devices with wireless communication circuits.

### Background Art

Mobile electronic communication devices are used by billions of people. The owners of such devices use them for many different purposes including, but not limited to, voice communications, text messaging, Internet browsing, calendar management, commerce such as banking, and social networking.

As these devices become more sophisticated, they can also become more complicated to operate. Illustrating by example, many “smart devices” now come equipped with touch sensitive displays rather than physical keyboards. While touching a surface is considered by some to be a simpler operation than working a complex keyboard, executing complex operations can require the navigation of several different menu tiers or user interface levels.

It would be advantageous to have simplified systems and methods for executing complex operations in modern electronic devices.

### BRIEF DESCRIPTION OF THE DRAWINGS

FIG. 1 illustrates one explanatory electronic device in accordance with one or more embodiments of the disclosure.

FIG. 2 illustrates one explanatory schematic block diagram with corresponding functional operations in accordance with one or more embodiments of the disclosure.

FIG. 3 illustrates one explanatory method in accordance with one or more embodiments of the disclosure.

FIG. 4 illustrates one or more method steps for an explanatory system in accordance with one or more embodiments of the disclosure.

FIG. 5 illustrates one or more method steps for an explanatory system in accordance with one or more embodiments of the disclosure.

FIG. 6 illustrates one or more method steps for an explanatory system in accordance with one or more embodiments of the disclosure.

FIG. 7 illustrates one or more method steps for an explanatory system in accordance with one or more embodiments of the disclosure.

FIG. 8 illustrates one or more method steps for an explanatory system in accordance with one or more embodiments of the disclosure.

FIG. 9 illustrates one or more method steps for an explanatory system in accordance with one or more embodiments of the disclosure.

FIG. 10 illustrates one or more method steps for an explanatory system in accordance with one or more embodiments of the disclosure.

FIG. 11 illustrates one or more method steps for an explanatory system in accordance with one or more embodiments of the disclosure.

FIG. 12 illustrates one or more method steps for an explanatory system in accordance with one or more embodiments of the disclosure.

FIG. 13 illustrates one or more method steps for an explanatory system in accordance with one or more embodiments of the disclosure.

FIG. 14 illustrates one or more method steps for an explanatory system in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to using biometric and/or motion or proximity sensors to authenticate a user of an electronic device to a companion device, and in particular to perform operations in companion devices requiring authentication. Any process descriptions or blocks in flow charts should be understood as representing modules, segments, or portions of code that include one or more executable instructions for implementing specific logical functions or steps in the process.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods operable on hardware platforms that, when applied to electronic device and/or user interface technology, improve the functioning of the electronic device itself by simplifying companion device operation by way of authentication at the companion device from a biometric sensor of the electronic device to improve the overall user experience by overcoming problems specifically arising in the realm of the recently developed technology associated with electronic device user interaction.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of providing user authentication to companion devices in response to biometric or gestures received at an electronic device as described herein. The non-processor circuits may include, but are not limited to, a radio receiver, a radio transmitter, signal drivers, clock circuits, power source circuits, and other user input devices.

As such, these functions may be interpreted as steps of a method to perform authentication processes to companion devices in response to one or more biometric sensor components receiving biometric input at an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide secure and simple methods of delivering authentication credentials to companion devices of an electronic device. Alternatively, embodiments can be used to deliver authentication credentials to applications operating on the electronic device itself. Delivery of the authentication credentials can be used for various purposes, including unlocking, actuating, or otherwise controlling companion devices that require authentication as a condition precedent and that are operable with an electronic device. For example, in one embodiment a user delivers a biometric input to a biometric sensor of an electronic device. The user might, for example, place a finger to deliver fingerprint data to a fingerprint sensor of a smartphone. The smartphone would be considered the “electronic device,” which may be operable with one or more companion devices.

Examples of companion devices may include music players, televisions, media players, lights, thermostats, appliances, locks, and so forth. The electronic device may be in electronic communication with these companion devices. However, user authentication may be required prior to the companion devices performing a particular function. For example, a user password may be required to unlock a screen saver on a tablet computer operating as a companion device to the smartphone in this illustrative example.

Rather than having to enter the password on the tablet computer directly, embodiments of the disclosure provide secure and simple methods of delivering authentication credentials to the tablet computer—or another companion device—when the companion device is in communication with the electronic device. Illustrating by example, in one embodiment a user can provide authentication to a companion device using a fingerprint sensor on a primary electronic device. By touching the fingerprint sensor, the user can cause authentication credentials to be delivered to the companion device. The companion device can then use these authentication credentials to perform one or more operations.

For instance, upon receiving authentication credentials, a companion device configured as a music player may sign-in to a streaming music service using the authentication credentials to start streaming music when the music player is operating within a wireless communication radius of the electronic device. Advantageously, this eliminates the need for a user to physically approach the music player, navigate to an application, and through the application, which may require several touches or user interactions with the display, perform the same operation.

In one or more embodiments, an electronic device includes a biometric sensor, one example of which is a fingerprint sensor. The biometric sensor is responsible for identifying biometric input received at the biometric sensor. One or more processors, which are operable with the biometric sensor, then identify one or more companion devices operating within a wireless communication radius of the electronic device. As noted above, the companion devices can include music players, tablet computers, wirelessly connected home devices and appliances, health trackers, tools, and so forth.

Once the user is identified from the biometric input, in one embodiment the one or more processors identify an authentication agent operating on at least one companion device. An authentication agent, as used herein, is a hardware or software tool configured to perform one or more functions in response to receiving authentication credentials. Examples of authentication credentials include user names, passwords, personal identification numbers, and so forth.

The authentication agent can be integral to the companion device in one embodiment. For example, where the companion device is a music player, an authentication credential may be required to actuate the music player to ensure that unauthorized personnel do not access the companion device without permission. Alternatively, the companion device may be a proxy for an authentication agent. If, for example, the companion device is a tablet computer, the user may desire to access a web portal operating in a web browser of the tablet computer. Accordingly, the tablet computer would serve as the proxy for the authentication agent of the web portal.

In one embodiment, when this occurs, i.e., when the authentication agent is identified, the one or more processors select an authentication credential for the authentication agent. Embodiments of the disclosure contemplate that different authentication agents may have different protocols for receiving and/or ingesting authentication credentials. Accordingly, the one or more processors may also optionally select an authentication tool that is operable with the authentication agent to ensure proper ingestion and delivery of the authentication credential to the authentication agent.

In one or more embodiments, the one or more processors then cause a wireless communication circuit to deliver the authentication credential to the authentication agent of the electronic device. As noted above, the authentication credential can be used in any of a variety of ways. The authentication credential can cause actuation the companion device, control the companion device, cause delivery of data to or from the companion device, or perform other control operations. Thus, in one embodiment, a user touches a fingerprint sensor and one or more processors deliver an actuation credential to a music streaming authentication agent operating on a companion wireless music player to start enjoying smooth jazz during cocktail hour.

Advantageously, embodiments of the disclosure provide a secure and fast way to lock, unlock, actuate, deactuate, or otherwise control a companion device. Where multiple companion devices are operating within the wireless communication radius, or alternatively when multiple authentication agents are operating on one or more companion devices, embodiments of the disclosure provide methods and systems for selecting between the various authentication agents. Illustrating by example, in one embodiment a list of authentication agents and/or their corresponding companion devices is presented on the display from which a user can select one or more authentication agents to which corresponding authentication credentials should be delivered. In another embodiment, an audible or other notification that there are multiple authentication agents operating on companion devices is delivered, from which a user may deliver an audible command such as “send user name and password to the streaming app on the music player” to select that particular authentication agent. In yet another embodiment, a context engine operating on the electronic device identifies one or more authentication agents based upon contextual cues or operating modes of the electronic device. Other techniques for alerting the user to the fact that there are multiple authentication agents operating within the predefined wireless radius will be obvious to those of ordinary skill in the art having the benefit of this disclosure.

In one or more embodiments, a biometric authentication is used at a first electronic device to authenticate a user to a companion device without the user needing to provide authentication directly to the companion device. Advantageously, the use of biometric authentication allows a user to use a single biometric sensor of a single device as a “universal remote control” that stores authentication credentials, and optionally authentication tools, for many different authentication agents.

Additionally, embodiments of the disclosure allow multiple users of a single companion device to use various user accounts with the same companion device. Where, for example, a family shared a music player had had different music streaming accounts, one family member would be able to listen to Tom Waits by causing their authentication credentials to be delivered with simple biometric input to their smartphone, while another member may be able to listen to Dave Brubeck with the same simple touch to their smartphone.

Illustrating by another example, if a family uses one tablet computer, the one or more processors operating within the tablet computer can identify a particular family member, and log into their social media account, by receiving an authentication credential for the social media account in response to biometric input being received at a remote device. Moreover, the remote biometric authentication also advantageously allows multiple users of a companion device to control differing access levels operating on that particular companion device. For instance, parents may not want their children to listen to heavy metal music. Accordingly, when a child is identified at a common music player, they may be allowed to control the music player, but only to play jazz, bluegrass, or classical music. By contrast, when the biometric sensor identifies a parent, they may be able to control the music player to listen to bone-crushing metal like there is no tomorrow. Other advantages of embodiments of the disclosure will be obvious to those of ordinary skill in the art having the benefit of this disclosure.

In one or more embodiments, the one or more processors executing the operations corresponding to interaction with the biometric sensor and the wireless communication circuit is a low-power, auxiliary processor. As will be described in more detail below, in one or more embodiments an electronic device is equipped with an application processor an auxiliary processor. As used herein, an “application” processor is configured to operate the primary applications of the electronic device, including the operating system environment. A “secondary” or “auxiliary” processor can be configured to operate ancillary or secondary functions. However, in one or more embodiments the auxiliary processor is operable with the biometric sensor and the wireless communication circuit to deliver authentication credentials to control companion devices operating within a predefined wireless communication radius in response to biometric input at the electronic device.

In one or more embodiments, the auxiliary processor is a low power processor having lower power consumption than the application processor. For example, in one embodiment the application processor is tasked with providing the operating system environment and for performing application operating functions of an electronic device. Accordingly, the application processor will consume relatively large amounts of power. By contrast, the auxiliary processor may perform a limited number of functions including, but not limited to, delivering authentication credentials to companion devices operating within a predefined wireless communication radius in response to biometric input.

Thus, in one or more embodiments the auxiliary processor is configured as a smaller component that consumes less power than an application processor. Biometric sensors and wireless communication circuits in accordance with embodiments of the disclosure can be configured to work with either device. However, in one or more embodiments control of companion devices in response to biometric input is advantageously performed by the auxiliary process to save power and extend operational run time of the electronic device. Embodiments of the disclosure contemplate that power savings—and thus longer runtime on a single battery charge—can be achieved by using the auxiliary processor, rather than the application processor, to deliver authentication credentials to companion device authentication agents.

In one or more embodiments, an electronic device includes a biometric sensor such as a fingerprint sensor responsible for identifying fingerprint data. The electronic device can include an application processor and an auxiliary processor, where the auxiliary processor consumes less power than the application processor. In one or more embodiments, the auxiliary processor is configured to determine, with a wireless communication circuit, one or more companion devices in communication with the electronic device. The auxiliary processor can further identify one or more authentication agents operating on the companion devices, as well as optionally receive a user selection of the authentication agent. When this occurs, the wireless communication circuit delivers an authentication credential to at least one companion device in response to the one or more motion sensors detecting the predefined gesture.

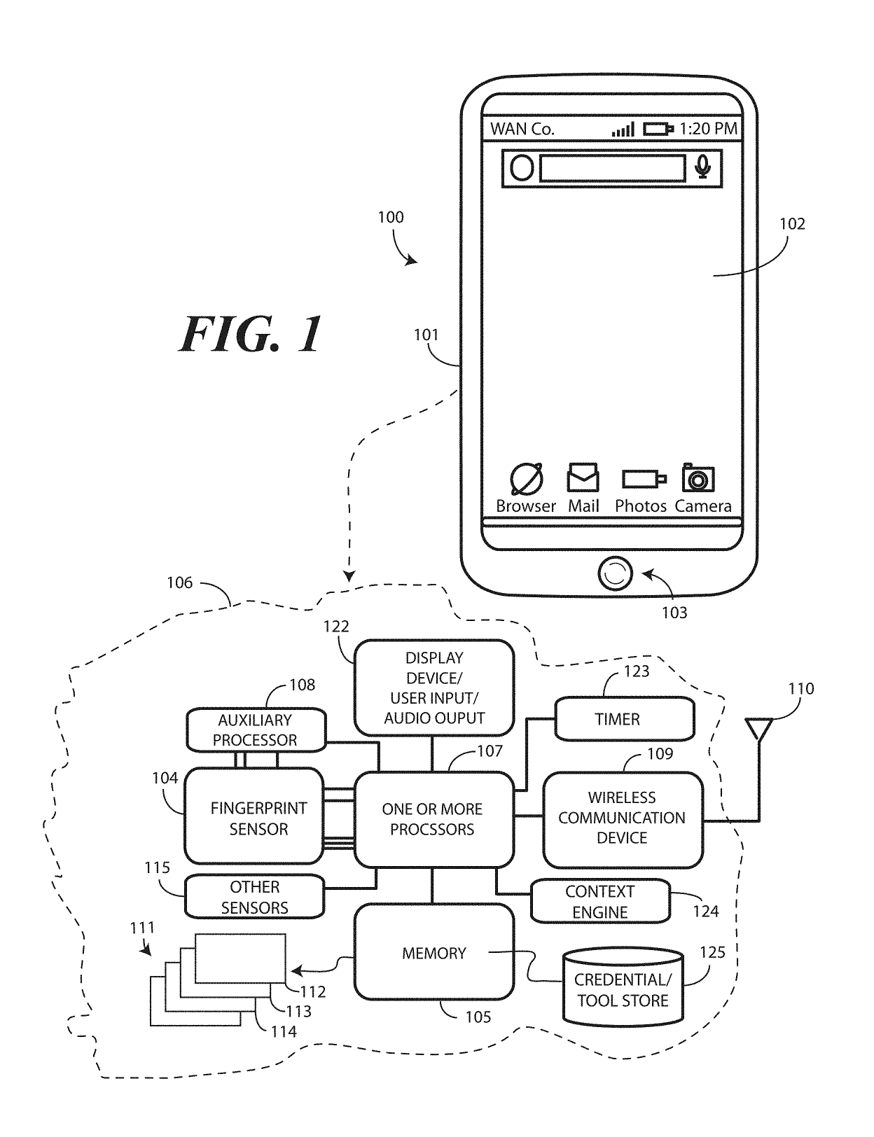

Turning now to FIG. 1, illustrated therein is one explanatory electronic device 100 configured in accordance with one or more embodiments of the disclosure. The electronic device 100 of FIG. 1 is a portable electronic device, and is shown as a smart phone for illustrative purposes. However, it should be obvious to those of ordinary skill in the art having the benefit of this disclosure that other electronic devices may be substituted for the explanatory smart phone of FIG. 1. For example, the electronic device 100 could equally be a palm-top computer, a tablet computer, a gaming device, a media player, or other wireless communication device.

This illustrative electronic device 100 includes a display 102, which in one embodiment is touch-sensitive and defines a primary user interface for the electronic device 100. Users can deliver user input to the display 102 of such an embodiment by delivering touch input from a finger, stylus, or other objects disposed proximately with the display. In one embodiment, the display 102 is configured as an organic light emitting diode (OLED) display fabricated on a flexible plastic substrate. However, it should be noted that other types of displays would be obvious to those of ordinary skill in the art having the benefit of this disclosure.

The explanatory electronic device 100 of FIG. 1 includes a housing 101. Features can be incorporated into the housing 101. In this illustrative embodiment, a biometric sensor 103 disposed along a surface of the housing 101. In one embodiment the biometric sensor 103 is responsible for identifying biometric input received at the biometric sensor 103 to authenticate or otherwise identify a user. Other devices can be disposed along the housing 101 as well. Examples of such devices include an optional camera or speaker port for an audio output device.

In one embodiment, the biometric sensor 103 is a fingerprint sensor 104. However, other types of biometric sensors that can be substituted for the fingerprint sensor 104 will be obvious to those of ordinary skill in the art having the benefit of this disclosure. For example, in other embodiments the biometric sensor 103 can be a voice interface engine. The voice interface engine can include hardware, executable code, and speech monitor executable code in one embodiment. The voice interface engine can include, stored in memory 105, basic speech models, trained speech models, or other modules that are used by the voice interface engine to receive and identify a particular user's voice commands that are received with audio input captured by an audio capture device. In one embodiment, the voice interface engine can include a voice recognition engine.

In another embodiment, the biometric sensor 103 can be an image/gaze detection-processing engine. The image/gaze detection-processing engine can be operable with physical sensors, such as a camera or intelligent imager, to process information detected from a user's gaze to identify the user through facial, eye, or other recognition techniques. The image/gaze detection-processing engine can also be configured to identify the user through facial recognition techniques by capturing photographs of the user. Other examples of biometric sensors 103 suitable for use with embodiments of the disclosure will be obvious to those of ordinary skill in the art having the benefit of this disclosure.

In one embodiment, the fingerprint sensor 104 includes its own processor to perform various functions, including detecting a finger touching the fingerprint sensor 104, capturing and storing fingerprint data from the finger, and optionally identifying or authenticating a user based upon the fingerprint data. In one or more embodiments the processor of the fingerprint sensor 104 can, as one pre-processing step, perform a preliminary authentication of the user by comparing fingerprint data captured by the fingerprint sensor 104 to a reference file stored in memory 105, while secondary authentication is performed by the application processor 107 or auxiliary processor 108. The processor of the fingerprint sensor 104 can be an on-board processor. Alternatively, the processor can be a secondary processor that is external to, but operable with, the fingerprint sensor in another embodiment. One example of which is the auxiliary processor 108. Other configurations will be obvious to those of ordinary skill in the art having the benefit of this disclosure.

In one embodiment, the fingerprint sensor 104 can include a plurality of sensors. The fingerprint sensor 104 can be a complementary metal-oxide-semiconductor active pixel sensor digital imager or any other fingerprint sensor. The fingerprint sensor 104 can be configured to capture, with the plurality of sensors, a live scan of a fingerprint pattern from a finger disposed along its surface, and to store this information as fingerprint data from the user's finger. The fingerprint sensor 104 may also be able to capture one or more images with the plurality of sensors. The images can correspond to an area beneath a surface of skin. The fingerprint sensor 104 can compare the fingerprint data or skin images to one or more references to authenticate a user in an authentication process.

While the biometric sensor 103 is disposed along a front surface of the housing 101 in this illustration, it should be noted that it could alternatively be disposed along the rear surface of the housing 101 in other embodiments. In still other embodiments, the biometric sensor 103 could be disposed beneath the display 102, thereby allowing the user to place a finger on the display 102 for identification.

In one embodiment, where the biometric sensor 103 is a fingerprint sensor 104, the fingerprint sensor 104 can be a single function device. In other embodiments, the fingerprint sensor 104 can be a dual or multifunction device. Illustrating by example, in one embodiment the fingerprint sensor 104 is solely responsible for receiving biometric data from a user and either authenticating the user or determining that the user is unauthorized to use the electronic device 100. This would be a single function fingerprint sensor.

In other embodiments, the fingerprint sensor 104 may be capable of performing multiple functions. Again illustrating by example, in one embodiment the fingerprint sensor 104 can receive biometric data from a user and either authenticate the user or determine that the user is unauthorized to use the electronic device 100. However, the fingerprint sensor 104 may also be configured as a push button. Thus, by touching the fingerprint sensor 104 the user may deliver biometric data only. However, by touching and pressing the fingerprint sensor 104, the fingerprint sensor 104 may both authenticate the user by receiving the biometric data from touch input and perform a second function in response to the push button being depressed.

The fingerprint sensor 104 can be configured to capture, with the plurality of sensors, a live scan of a fingerprint pattern from a finger disposed along its surface, and to store this information as fingerprint data from the user's finger. The fingerprint sensor 104 may also be able to capture one or more images with the plurality of sensors. The images can correspond to an area beneath a surface of skin. The fingerprint sensor 104 can compare the fingerprint data or skin images to one or more references to authenticate a user in an authentication process.

A block diagram schematic 106 of the electronic device 100 is also shown in FIG. 1. In one embodiment, the electronic device 100 includes one or more processors. In one embodiment, the electronic device includes an application processor 107 and an auxiliary processor 108. One or both of the application processor 107 or the auxiliary processor 108 can include one or more processors. One or both of the application processor 107 or the auxiliary processor 108 can be a microprocessor, a group of processing components, one or more Application Specific Integrated Circuits (ASICs), programmable logic, or other type of processing device. The application processor 107 and the auxiliary processor 108 can be operable with the various components of the electronic device 100. Each of the application processor 107 and the auxiliary processor 108 can be configured to process and execute executable software code to perform the various functions of the electronic device 100. A storage device, such as memory 105, can optionally store the executable software code used by the application processor 107 or the auxiliary processor 108 during operation.

As noted above, in one or more embodiments the auxiliary processor 108 is a low power processor having lower power consumption than the application processor 107. For example, in one embodiment the application processor 107 is tasked with providing the operating system environment and for running various applications operating on the electronic device 100. Accordingly, the application processor 107 can consume relatively large amounts of power.

For example, in one embodiment, the application processor 107 is responsible for running the operating system environment 111. The operating system environment 111 can include a kernel 112 and one or more drivers, and an application service layer 113, and an application layer 114. The operating system environment 111 can be configured as executable code stored in memory 105.

The application layer 114 can be responsible for executing application service modules. The application service modules may support one or more applications or “apps.” The applications of the application layer 114 can be configured as clients of the application service layer 113 to communicate with services through application program interfaces (APIs), messages, events, or other inter-process communication interfaces.

By contrast, the auxiliary processor 108 may perform a limited number of functions including, but not limited to, controlling companion devices operating within a predefined wireless communication radius in response to biometric input and gesture detection. Thus, in one or more embodiments the auxiliary processor 108 is configured as a smaller component that consumes less power than an application processor 107. Where control of companion devices in response to biometric and gesture input is advantageously performed by the auxiliary processor 108, this saves power and extends operational run time of the electronic device 100. Advantageously, power savings are achieved by using the auxiliary processor 108, rather than the application processor 107, to control companion device operations in one or more embodiments.

In this illustrative embodiment, the electronic device 100 also includes a wireless communication circuit 109 that can be configured for wired or wireless communication with one or more companion devices operating within a predefined wireless communication radius. The wireless communication circuit 109 can also be operable to communicate across one or more networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The wireless communication circuit 109, in one embodiment, may also utilize wireless technology for communication across networks having a limited wireless communication radius. Such networks include, but are not limited to, peer-to-peer or ad hoc communications such as HomeRF, Bluetooth and IEEE 802.11(a, b, g or n), and other forms of wireless communication such as infrared technology. The wireless communication circuit 109 can include wireless communication circuitry, one of a receiver, a transmitter, or transceiver, and one or more antennas 110.

One or more other sensors 115 can be operable with one or more of the application processor 107, the auxiliary processor 108, or combinations thereof. In one embodiment, the other sensors 115 include motion sensors, such as one or more accelerometers or gyroscopes. For example, an accelerometer may be embedded in the electronic circuitry of the electronic device 100 to show vertical orientation, constant tilt and/or whether the electronic device 100 is stationary. A gyroscope can be used in a similar fashion. An altimeter can be included as one of the motion sensors 116 as well. Regardless of the type of motion sensors that are used, they can be operable to detect movement, and direction of movement, of the electronic device 100 by a user, such as when a user pivots, rotates, elevates, translates, or otherwise moves the electronic device 100.

In one or more embodiments, the other sensors 115 also include one or more proximity sensors. The proximity sensors can be used, for example, to compute the distance to any nearby object from characteristics associated with received or reflected signals.

In one embodiment, the auxiliary processor 108 may generate commands or execute control operations based on information received the fingerprint sensor 104 or other biometric sensor 103. The auxiliary processor 108 may also generate commands or execute control operations based upon information received from one or a combination of these sensors. Moreover, the auxiliary processor 108 may process the received sensor information alone or in combination with other data, such as the information stored in the memory 105.

The one or more other sensors 115 may additionally include a microphone, an earpiece speaker, a second loudspeaker, and/or a component of a user interface 122, such as a button. The one or more other sensors 115 may also include key selection sensors, a touch pad sensor, a touch screen sensor, a capacitive touch sensor, and one or more switches. Touch sensors may used to indicate whether any of the user actuation targets present on the display 102 are being actuated. Alternatively, touch sensors disposed in the housing 101 can be used to determine whether the electronic device 100 is being touched at side edges or major faces of the electronic device 100 are being performed by a user. The touch sensors can include surface and/or housing capacitive sensors in one embodiment. The other sensors 115 can also include audio sensors and video sensors (such as a camera).

A timer 123 can be operable with one or more of the application processor 107 or the auxiliary processor 108. One or both of the application processor 107 or the auxiliary processor 108 can initiate the timer 123 during control operations or method steps. When the timer 123, in one embodiment one or more of the application processor 107 or the auxiliary processor 108 can perform certain control operations when events do, or do not, transpire prior to expiration of the timer 123. Other uses for the timer 123 will be obvious to those of ordinary skill in the art having the benefit of this disclosure.

A context engine 124 can be operable with one or more of the application processor 107 or the auxiliary processor 108. The context engine 124 is operable to infer context from data of the electronic device 100. Illustrating by example, as will be described in more detail below, when one or more of the application processor 107 or the auxiliary processor 108 identifies one or more authentication agents operating one or more companion devices, the context engine 124 may select a particular authentication agent to which an authentication credential should be sent. If, for instance, the electronic device 100 is executing a screen mirroring operation, and a web portal is operational on the display of the companion device, with that web portal being mirrored on the display 102 of the electronic device 100, the context engine 124 may select an authentication credential for this web portal, concluding that the user wishes to access it because it is presently being presented on the display.

In another embodiment, the context engine 124 can be operable with a camera or intelligent imager that is included with the other sensors 115. Where this is the case, the camera or intelligent imager can use data captured in images to infer to which authentication agent an authentication credential should be transmitted. Illustrating by example, the context engine 124 may analyze a photograph of a room to identify a companion device, such as a music player, being operable within a predefined communication radius. If no other companion device is identified, the context engine 124 may select an authentication credential for the music player.

The context engine 124 may analyze other data to infer context, including calendar events, user profiles, device operating states, energy storage within a battery, application data, data from third parties such as web services and social media servers, alarms, time of day, behaviors a user repeats, and other factors to select one or more authentication agents to which authentication credentials should be sent. The context engine 124 can be configured as either hardware components, or alternatively as combinations of hardware components and software components. The context engine 124 can be configured to collect and analyze non-physical parametric data. Other uses for the context engine will be obvious to those of ordinary skill in the art having the benefit of this disclosure.

It is to be understood that FIG. 1 is provided for illustrative purposes only and for illustrating components of one electronic device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

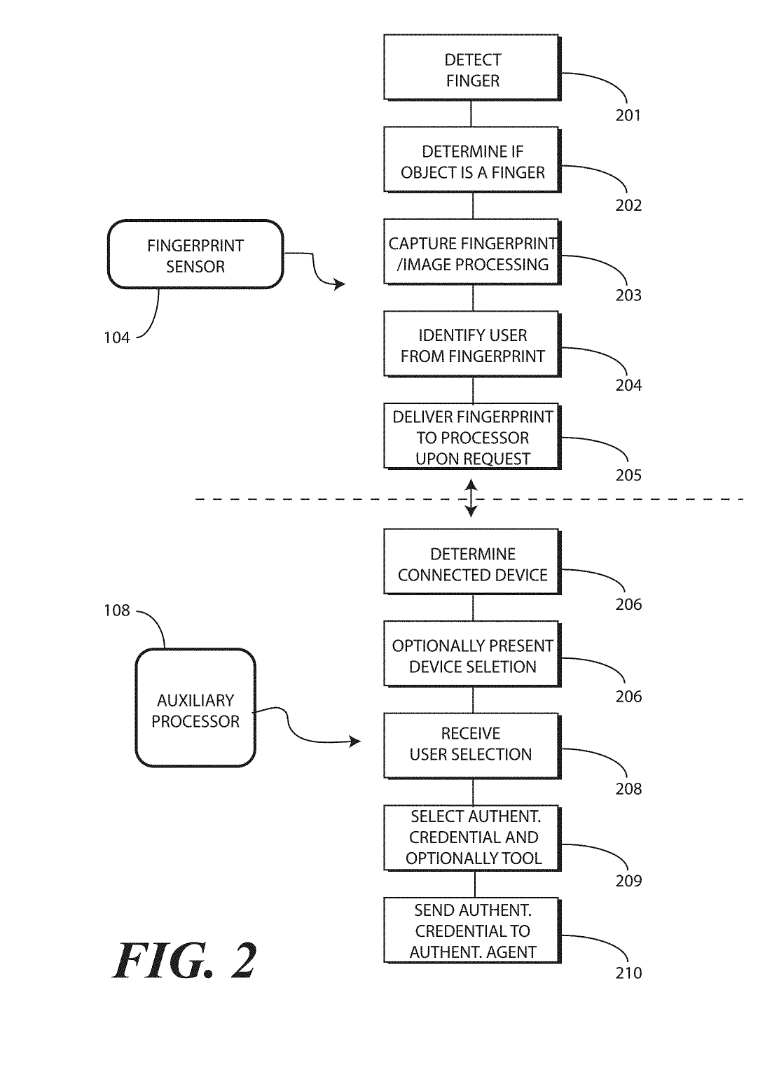

Turning now to FIG. 2, illustrated therein are some of the interactions that can occur between the fingerprint sensor 104 and the auxiliary processor 108 in accordance with one or more embodiments of the disclosure. It should be noted that where no auxiliary processor 108 is included, the auxiliary processor functions shown in FIG. 2 can be performed by the application processor (107) of the electronic device (100) instead. Similarly, where an auxiliary processor 108 is included, but is tasked with performing other operations, the application processor (107) of the electronic device (100) can optionally perform one or more of the auxiliary processor functions shown in FIG. 2 as well.

In one embodiment, the fingerprint sensor 104 is to detect a finger proximately located with the fingerprint sensor 104. As a part of the detection process, the fingerprint sensor 104 can enter an input reception mode upon an object contacting the surface of the fingerprint sensor 104.

In one embodiment, the fingerprint sensor 104 can optionally be configured to determine 202 that the object touching or otherwise proximately located with the fingerprint sensor 104 is actually a finger and not an object incapable of authentication. Where the object is a finger, the fingerprint sensor 104 can then capture 203 fingerprint data from the finger and perform other pre-processing such as noise filtering and so forth.

In one or more embodiments, the fingerprint sensor 104 is further to authenticate or identify 204 a user from the fingerprint data received at 203. This step can optionally be performed by the auxiliary processor 108 as well. For example, in one embodiment, one of the fingerprint sensor 104 or the auxiliary processor 108 can perform a matching function. The fingerprint sensor 104 or the auxiliary processor 108, after having received the fingerprint data, can then perform a matching process to determine whether the fingerprint data substantially matches reference data stored in memory. In one embodiment, upon receiving a request from the auxiliary processor 108 for the fingerprint data, the fingerprint sensor 104 can deliver 205 the fingerprint data to the auxiliary processor 108.

If the electronic device (100) is locked, in one embodiment step 205 can additionally include unlocking the electronic device (100) so that it can be actively used by the user. In one embodiment, a second finger operation may be required for authentication agent selection. Accordingly, in one embodiment the method can return to step 201. However, in other embodiments unlocking the electronic device (100) and moving to step 206 can occur sequentially.

In still other embodiments, no electronic device unlocking is required. For example, in an electronic device (100) having an “always ON” display that can present notifications to a user while in a locked state, it may be unnecessary to unlock the electronic device (100) when initially in a locked state. With context information presentable on an always ON display, the method may move to step 206 while the electronic device (100) stays locked.

The auxiliary processor 108, meanwhile, can work with the wireless communication circuit (109) to be responsible for identifying 206 one or more companion devices operating within a wireless communication radius of the electronic device (100). “Companion devices” refer to devices that are in communication with, or alternatively are paired with using a local area network protocol such as Bluetooth.sup.TM, with the electronic device (100).

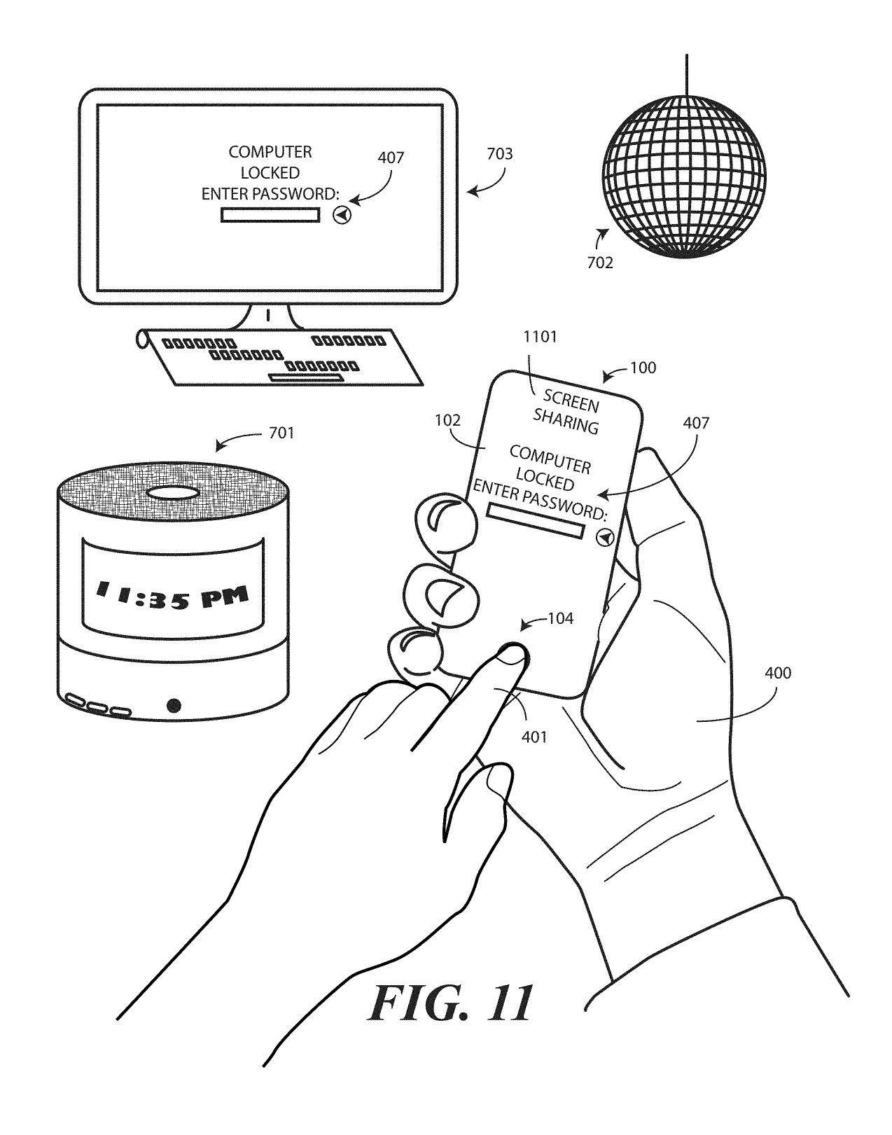

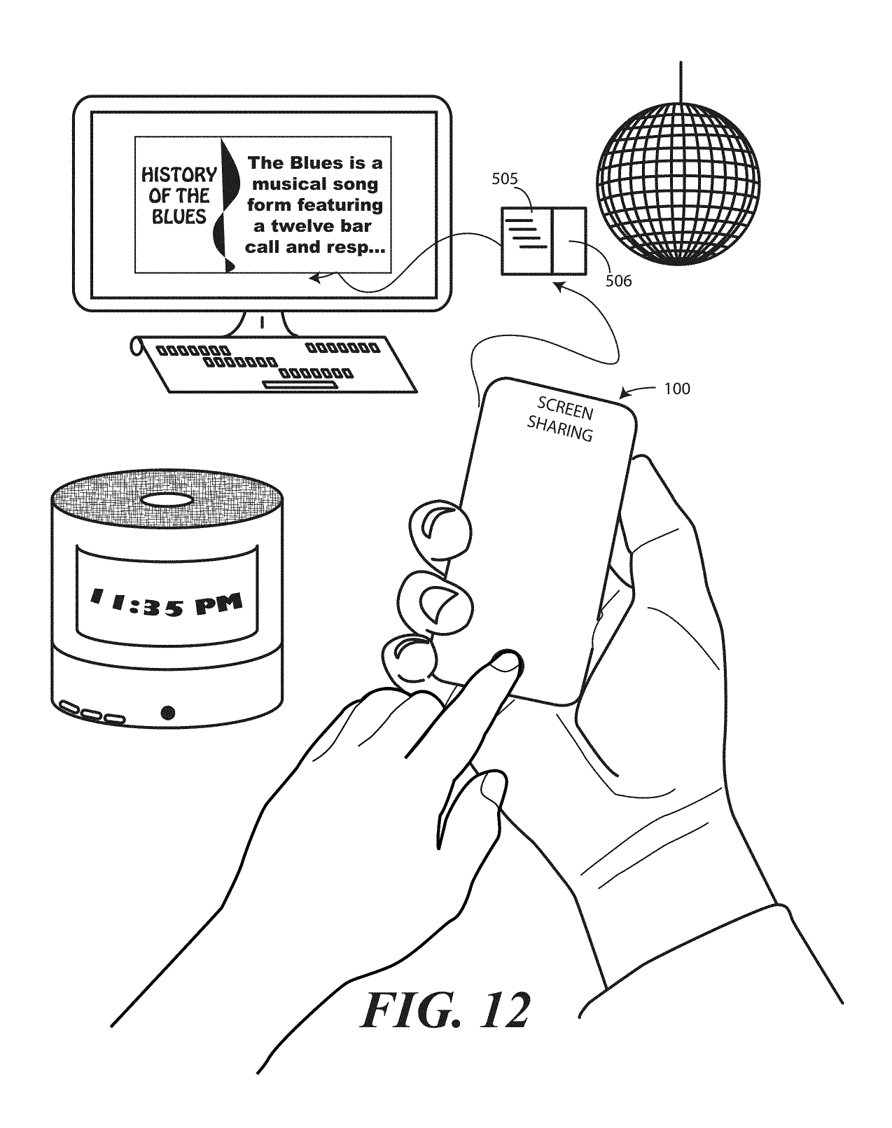

In some situations, the auxiliary processor 108 will identify 206 at least one authentication agent operating on at least one companion device operating within the wireless communication radius defined by the particular protocol with which the wireless communication circuit (109) is communicating. This can occur in a number of ways. In one embodiment, the wireless communication circuit (109) queries nearby devices to identify 206 these devices. In other embodiments, the companion devices will be trusted devices in communication with the electronic device (100) and will be identified 206 during the pairing process. In still other embodiments, the authenticating agent operating on the companion device may identify 206 itself by transmitting an authentication request to the electronic device (100). These techniques can be used alone or in combination. Other techniques will be obvious to those of ordinary skill in the art having the benefit of this disclosure.

Where more than one authentication agent or companion device is identified, the auxiliary processor 108 can optionally provide 207 an identification of the multiple companion devices with a user interface (122) of the electronic device (100). Illustrating by example, in one embodiment the auxiliary processor 108 can present a list of the multiple companion devices along the display (102). In another embodiment, the auxiliary processor 108 can deliver identification of the multiple companion devices audibly through a loudspeaker. In other embodiments described below with reference to FIGS. 11-12, a context engine (124) can select a particular authentication agent operating on a companion device. Still other techniques for providing 207 an identification of the multiple companion devices will be obvious to those of ordinary skill in the art having the benefit of this disclosure.

Upon identifying at least one authentication agent operating on at least one companion device operating within the wireless communication radius, where not selected by the context engine (124) or other techniques, in one embodiment the auxiliary processor 108 can receive 208 a user selection of a particular authentication agent or agents operating on a corresponding particular companion device or devices. As with the identification of the various authentication agents, the auxiliary processor 108 can receive 208 the selection in various ways.

In one embodiment, where the auxiliary processor 108 presents a list of the multiple authentication agents operating on one or more companion devices along the display (102), a selection can be received 208 when a user touches a user actuation target corresponding to a particular authentication agent or agents. In another embodiment, where the auxiliary processor 108 delivers the identification of the multiple authentication agents audibly through a loudspeaker, the auxiliary processor 108 may receive 208 the selection of a particular authentication agent or agents as voice input through a microphone included with the other sensors (115). In one or more embodiments, identification of a particular authentication agent occurs in response to an authentication request sent by an authentication agent operating on the companion device. Other techniques for receiving 208 a selection of one or more authentication agents from an identification of multiple authentication agents will be obvious to those of ordinary skill in the art having the benefit of this disclosure.

The auxiliary processor 108 can also select 209 an authentication credential for each selected authentication agent. In one embodiment, the auxiliary processor 108 selects 209 the authentication credential from an authentication credential store (125) storing a plurality of authentication credentials. In one or more embodiments, the authentication credentials residing in the authentication credential store (125) may be synced with another device across a network. In such a configuration, if a user has a smartphone and a tablet computer, with an authentication credential for a particular website stored in a memory of the smartphone, when the user attempts to navigate to the website with the tablet computer, and the authentication credential is not stored locally in an authentication credential store, in one embodiment the tablet computer can sync the authentication credential from the smartphone.

The auxiliary processor can optionally select 209 selecting at least one actuation tool operable with the at least one authentication agent for ingestion of the at least one authentication credential. The authentication tool may work to execute operations, such as selecting a particular window or portal for various authentication credential components, such as entering a user name in a first window, toggling to a second window to enter a password, and then executing an operation to cause the authentication agent to ingest the password, such as executing an “enter key depress” operation or toggling a user interaction target.

The auxiliary processor 108 can then cause the wireless communication circuit (109) to deliver 210 at least one authentication credential to at least one authentication agent operating on at least one companion device. Where selected and/or necessary, in one embodiment the auxiliary processor 108 can further cause the wireless communication circuit (109) to deliver 210 the at least one actuation tool with the at least one authentication credential. This process will be explained in more detail below with reference to the remaining figures.

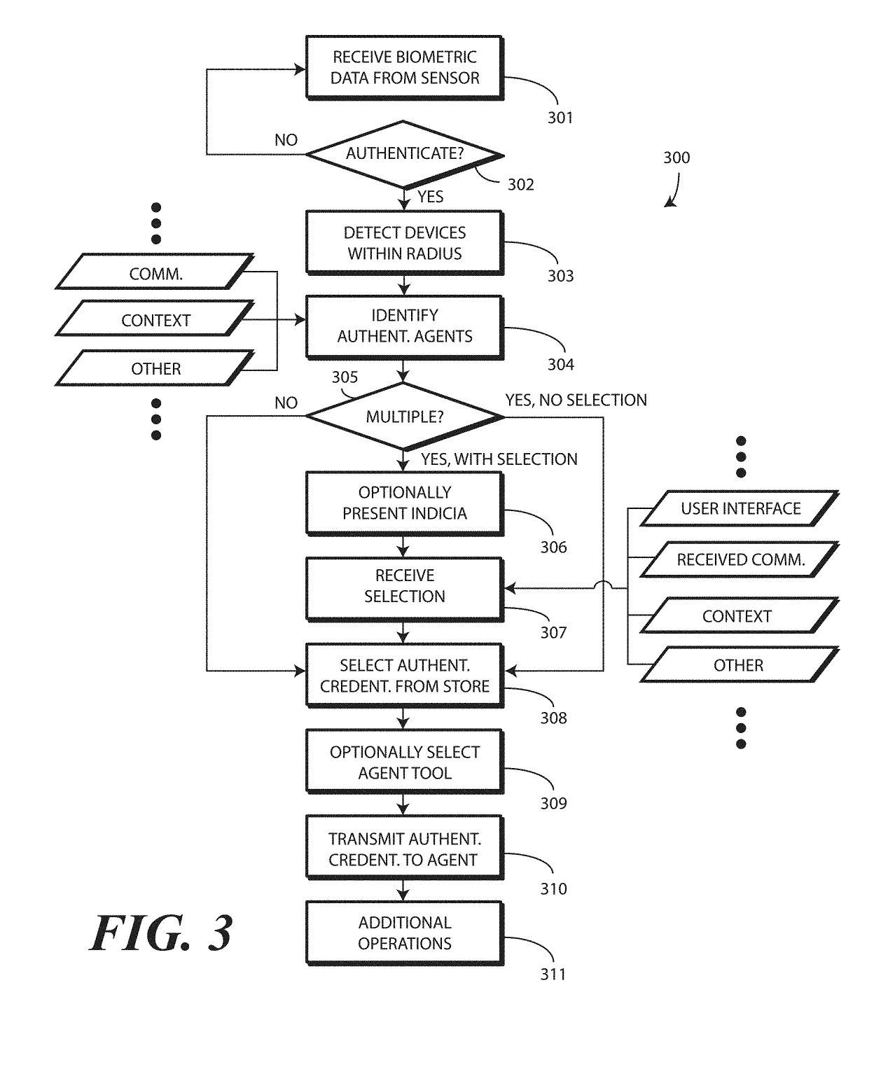

Now that the various hardware components have been described, attention will be turned to methods and use cases in accordance with one or more embodiments of the disclosure. Turning now to FIG. 3, illustrated therein is one explanatory method 300 for controlling one or more companion devices in accordance with one or more embodiments of the disclosure.

At step 301 a biometric sensor of a first electronic device identifies biometric input. For example, in one embodiment step 301 includes a fingerprint sensor detecting an object touching the fingerprint sensor. In one embodiment, step 301 includes the fingerprint sensor scanning the finger to receive fingerprint data from the finger.

At decision 302, the method 300 can perform an authentication process to identify the fingerprint data received from the finger as described above. Illustrating by example, in one embodiment the fingerprint sensor, after detecting a finger touching the fingerprint sensor and capturing and storing fingerprint data from the finger, can compare the fingerprint data captured by the fingerprint sensor to a reference file stored in memory to determine whether the fingerprint data can be identified. This in turn determines whether the user can be authenticated. Both determinations occur at decision 302. Said differently, in one embodiment, decision 302 includes the biometric sensor determining whether biometric input can identify a user to to authenticate the user. Where a user is identified from the fingerprint data, the method proceeds to step 303. Otherwise, the method returns to step 301.

Assuming the user is authenticated at decision 302, in one embodiment the method 300 moves to step 303 where a number of companion devices operating within a wireless communication radius is determined. This can be accomplished in a variety of ways. In one embodiment, a wireless communication circuit of the electronic device initiates an introduction or handshaking process via electronic communication to determine whether companion devices are operating within a wireless communication radius. In another embodiment, the wireless communication circuit will search for one or more networks operating within the wireless communication radius. Upon detecting networks, the wireless communication circuit can query those networks to identify companion devices. In other embodiments, the companion devices will be “trusted” or “paired” devices that are in peer-to-peer or ad hoc networks with the electronic device. In still other embodiments, the authenticating agent operating on the companion device may identify itself by transmitting an authentication request to the electronic device. These techniques can be used alone or in combination. Other techniques will be obvious to those of ordinary skill in the art having the benefit of this disclosure. Other techniques for identifying companion devices will be obvious to those of ordinary skill in the art having the benefit of this disclosure.

At step 304, the method 300 identifies at least one authentication agent operating on at least one companion device. As with the detection of companion devices, this can be accomplished in various ways. In one embodiment, a user selection identifies a particular authentication agent operating on a second, companion device. If, for example, a user's smartphone is paired with a computer, and the user wishes to stream video to the computer, the user may select, using the display of the smartphone, an authentication agent for the computer, for the streaming video service, or both.

In another embodiment, a wireless communication circuit may identify authentication agents by exchanging electronic communications with the companion devices. The wireless communication circuit may query each companion device to determine which authentication agents are operating on, or are available on, those companion devices. Alternatively, an authentication agent operating on a companion device can send an authentication request to the electronic device. In another embodiment, a context engine can identify authentication agents. If, for example, a first device a smart device has a web browser operating thereon, the context engine may conclude that the user wishes to send authentication credentials to the currently presented website. Accordingly, the context engine may identify one or more authentication agents by identifying operational authentication agents operating on the local device or a companion device. Other techniques for identifying authentication agents will be obvious to those of ordinary skill in the art having the benefit of this disclosure.

If no companion devices, or alternatively no authentication agents, are identified at steps 303, 304, the method 300 can optionally notify the user through a user interface that no companion devices have been detected. However, where at least one companion device and/or at least one authentication agent has been detected, decision 305 determines whether one authentication agent or multiple authentication agents have been detected. Where one, the method proceeds to step 308.

Where there are authentication agents detected, in one embodiment the method 300 optionally notifies the user of this fact at step 306. Methods for providing this notification have been described above with reference to FIG. 2. Illustrating by example, an electronic device may present a list of the multiple authentication agents along its display. A selection can then be received when a user touches a user actuation target corresponding to a particular device. Alternatively, the electronic device may present the list of multiple authentication agents as audible output from a loudspeaker. A selection may be received as voice input through a microphone. Still other techniques for providing an identification of the multiple authentication agents will be obvious to those of ordinary skill in the art having the benefit of this disclosure.

In one embodiment, the method 300 simply selects all available authentication agents. Accordingly, in one embodiment where multiple authentication agents are identified, the method simply moves from decision 305 to step 308.

However, in other embodiments, a selection of a subset of authentication agents occurs. At step 307, the method 300 selects one or more authentication agents from the multiple authentication agents. As with detection of the authentication agents, this can occur in a variety of ways. In one embodiment, the user simply makes a selection, using the user interface of the electronic device for example, of those authentication agents to which it wishes authentication credentials be sent. The user may also deliver the selection by voice command where the electronic device is equipped to process such commands. In yet another embodiment, electronic communication can be used to select particular authentication agents. Where, for example, companion devices operate windows, each containing an authentication agent, an identification of the currently active, highest priority, top tier, or otherwise most relevant authentication can be delivered through electronic communications. In still other embodiments, the context engine can determine a contextual operating condition of the electronic device, such as a mode of operation, a currently operating application, or a user defined operating environment. Where this occurs, the selection at step 307 can be a function of the contextual operating condition determined by the context engine.

Thus, in one embodiment the identifying of authentication agents occurring at step 304 comprises identifying a plurality of authentication agents. The identifying, or selecting, which of those authentication agents should receive authentication credentials at step 307 can comprise receiving a selection of the at least one authentication agent from a user interface. In another embodiment, the selecting at step 307 can also occur from wireless communication. The selecting at step 307 can also be in response to a context engine detecting a contextual operating condition of an electronic device. Still other mechanisms and techniques for selecting one or more authentication agents will be obvious to those of ordinary skill in the art having the benefit of this disclosure. Regardless of the technique, the selection occurring at step 307 can select one authentication agent or multiple authentication agents.

At step 308, the method 300 selects at least one authentication credential for at least one authentication agent. The authentication credential could be simple, e.g., a user name and a password. Alternatively, the authentication credential may include one or more layers. Illustrating by example, there may be multiple encrypted files or authentication objects operating on a companion device. In such a scenario, multiple layers of authentication credentials, such as a device credential, an authentication agent credential, a file encryption authentication credential, and a file authentication credential may be required. These layered credentials can be packaged into an authentication entity package in one embodiment. The number of layers and corresponding authentication credentials may vary based upon context. The example above is illustrative only.

Where only one authentication agent is identified at step 304, step 308 selects one authentication credential or layers of credentials, if required. Where multiple authentication agents are identified at step 304, and no selection was made, i.e., when the method 300 proceeds directly from decision 305 to step 308, the method selects an authentication credential for each authentication agent. In another embodiment, here multiple authentication agents are identified at step 304 and a selection is made, i.e., when the method 300 proceeds directly from decision 305 through step 307 to step 308, the method selects an authentication credential for each selected authentication agent. Thus, in one embodiment where the identifying at step 304 comprises identifying a plurality of authentication agents, the selecting at step 308 comprises selecting a plurality of authentication credentials corresponding to the plurality of authentication agents, which can be all authentication agents or only a subset of selected authentication agents.

At step 309, the method 300 also optionally selects an authentication tool. In one embodiment the authentication tool provides a device and/or service specific authentication actuator and interface for the authentication agent. Illustrating by example, for online accounts a browser plugin frequently serves as the authentication agent. Its role is to capture the online account details and to send authentication credentials to a remote server. Upon receiving the authentication credentials, a corresponding authentication tool can perform auto fill and login actions to ensure that the authentication credentials are properly ingested into the authentication agent. By contrast, on a computer, the authentication agent may integrate with the operating system. Accordingly, its authentication credential ingest process would be different. To accommodate this difference, in one embodiment the method 300 would select a different authentication tool at step 309 for the computer than for the browser plugin. The inclusion of different authentication tools advantageously allows a user to provide a “single action” authentication by touching a biometric sensor on a mobile device while delivering authentication credentials to a wide variety of devices, operating systems, software applications, and plugins.

At step 310, the method 300 delivers the authentication credential to at least one authentication agent operating on at least one companion device. In one embodiment, step 310 comprises delivering multiple authentication credentials to multiple authentication agents. Step 310 can optionally include delivering an actuation tool as well.

The authentication credential can take a number of different forms. In its most basic form, the authentication credential can comprise information used to authenticate a user to a particular authentication agent. This can be a user name, password, personal identification number, or other identification credentials. In one embodiment, the authentication credential is encrypted. The authentication tool can optionally decrypt the authentication credential at the authentication agent for ingestion. In other embodiments, the authentication credential can comprise keys or tokens that provide a security or authentication notification. For example, the authentication credential may indicate both an action that the companion device should preform and an indication that a particular user has been identified. Other types of authentication credentials will be obvious to those of ordinary art having the benefit of this disclosure.

Actions taken after receiving the authentication credential can vary depending upon what a particular authentication agent is operable with. For example, after receiving authentication credentials an authentication agent can deliver an electronic message commanding or authorizing a companion device to take a particular action. Examples of such actions include turning ON, turning OFF, selecting content to play, fast forwarding, rewinding, skipping, and so forth. The actions will vary based upon the application and the type of companion device.

Other operations can occur at step 311. For example, in one embodiment step 311 comprises notifying the user that an authentication credential has been successfully delivered. A companion device or authentication agent may send an acknowledgement message in response to receiving the authentication credential. In one or more embodiments, the method 300 may optionally notify the user transmission of the authentication credential was successful at step 311.

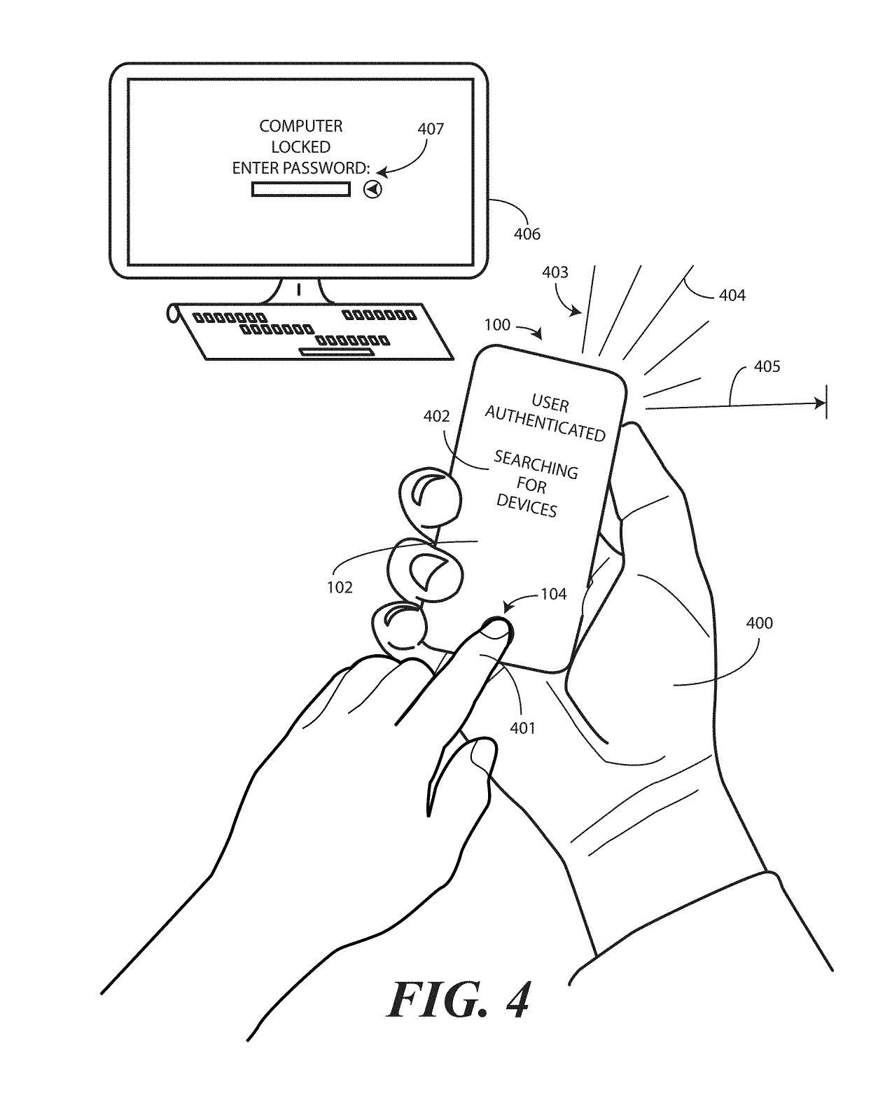

To further illustrate the unique features of embodiments of the disclosure, the various method steps of FIGS. 2-3, and hardware components of FIG. 1, will now be described with the electronic device in use. Turning now to FIG. 4, a user 400 places their finger 401 on a fingerprint sensor 104 of an electronic device. When this occurs, the fingerprint sensor 104 identifies fingerprint data from the user's finger 401 to authenticate the user.

As noted above, in one or more embodiments the electronic device 100 includes both an application processor (107) and an auxiliary processor (108). In one embodiment, the auxiliary processor then determines 403, through the exchange of wireless communication signals 404 from a wireless communication circuit (109) in this illustrative embodiment, whether one or more companion devices are in communication with the electronic device 100 within a wireless communication radius 405. The electronic device 100 then identifies at least one authentication agent operating on at least one companion device.

In this example, a computer 406 is a companion device, paired with and trusted to the electronic device 100, operating within the wireless communication radius 405. The computer 406 includes an authentication agent 407 that requires authentication credentials in the form of a password for access. Accordingly, using the wireless communication signals 404, the electronic device is able to authenticate both the companion device, i.e., the computer 406, and the authentication agent 407 operating on the companion device. In one or more embodiments, a notification 402 can be presented on the display 102 to let the user 400 know what is occurring.

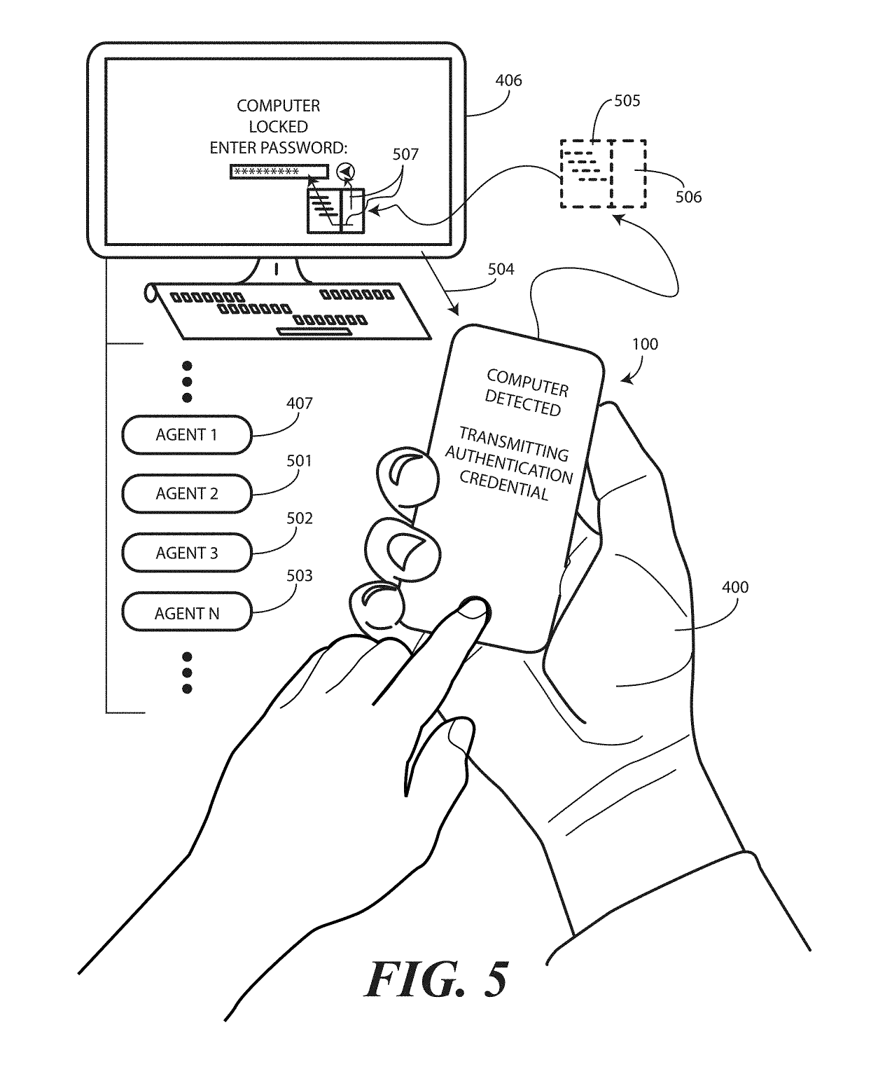

Turning to FIG. 5, the electronic device 100 has identified a plurality of authentication agents 407, 501, 502, 503 operating within the wireless communication radius (605). For example, the first authentication agent 407 is the authentication agent for the computer 406 or its operating system. A second authentication agent 501 may be for an applet operating in a web browser. A third authentication agent 502 may be operable with a streaming music service. A fourth authentication agent 503 may be operable with a social media site, and so forth.

In this illustration, since the user 400 must access the computer 406 prior to being able to access any of authentication agents 501, 502, 503, the electronic device 100 receives, with its wireless communication circuit (109), an electronic communication 504 comprising a selection of the highest tier authentication agent, i.e., authentication agent 407 from the computer 406.

When this occurs, either the auxiliary processor (108) or application processor (107) can then select an authentication credential 505 for the authentication agent 407. In this embodiment, the auxiliary processor (108) or application processor (107) additionally selects an actuation tool 506 operable with the authentication agent 407 for ingestion 507 of the authentication credential into the authentication agent 407. The wireless communication circuit (109) of the electronic device, which is responsive to the auxiliary processor (108) or the application processor (107), then delivers (508) the authentication credential 505 to the authentication agent 407 of the companion device. Here, the wireless communication circuit (109) also transmits the actuation tool 506 with the authentication credential 505. The actuation tool 506 then loads the authentication credential 505 into the authentication agent 407, and presses a user actuation target to cause the authentication agent 407 to ingest 507 the authentication credential 505.

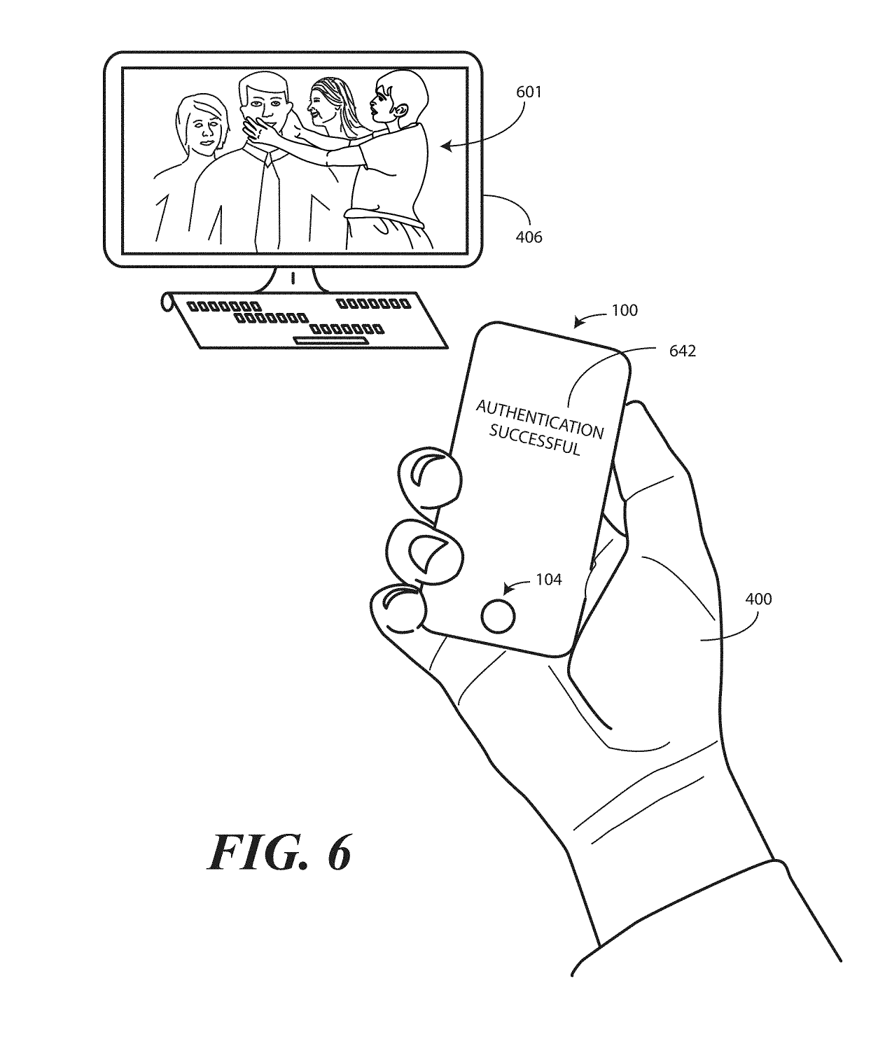

As shown in FIG. 6, in this illustrative embodiment the authentication credential (505) unlocks the computer 406. A wallpaper image 601 of the user's family appears on the display of the computer. In this illustrative example, the auxiliary processor (108) or the application processor (107) additionally provides a notification 602 with the user interface of the electronic device 100 that the authentication credential (505) was successfully delivered by the wireless communication circuit (109).

Thus, as shown in FIGS. 5-6, embodiments of the disclosure allow the electronic device 100, and its fingerprint sensor 104, to create a seamless way to authenticate devices and services. By using the fingerprint sensor 104 for authentication, the user 400 need not worry about entering different passwords and user names on every different user interface associated with each authentication agent. To the contrary, the electronic device 100 serves as a single point of authentication credential storage that is protected by the fingerprint sensor 104. Only one copy of any authentication credential need be stored in the electronic device 100. The electronic device 100 thus acts as a physical key that protects the various authentication credentials stored therein.

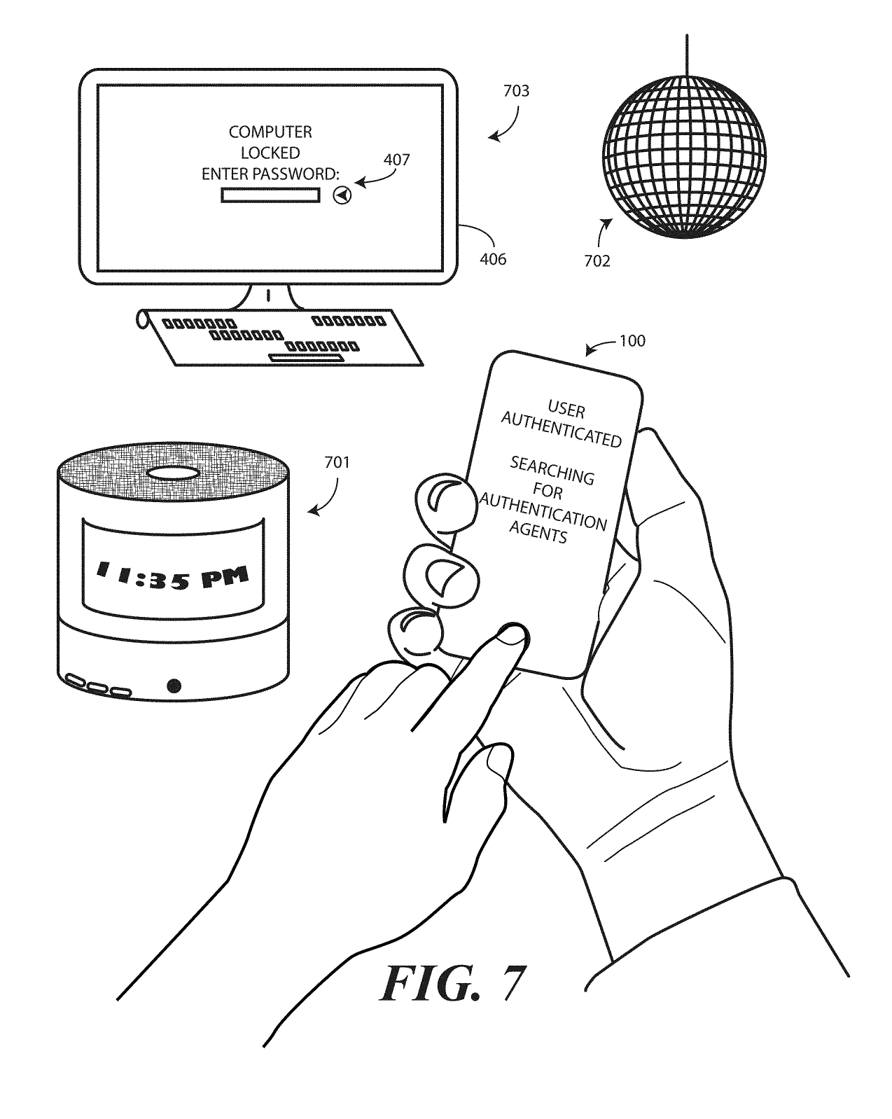

Turning to FIG. 7, in this example the electronic device 100 has identified a plurality of companion devices. Here, a first companion device 701 is a music player that is paired with the electronic device 100 by a Bluetooth.sup.TM connection. The second companion device 702 is a disco strobe light that is communicating with the electronic device 100 through a router in a Wi-Fi network. The third companion device 703 is the computer 406, which is a trusted device paired with the electronic device 100 through a peer-to-peer ad hoc network. These devices merely provide some examples of companion devices for illustration. Others will be readily apparent to those of ordinary skill in the art having the benefit of this disclosure.

In this embodiment, each companion device has an authentication agent operating therewith. The first companion device 701 receives music from a music streaming service that is interfaced through a first authentication agent. The second companion device 702 has an authentication agent that only allows trusted devices to control the disco strobe light. The authentication agent 407 of the third companion device 703 has been previously described.

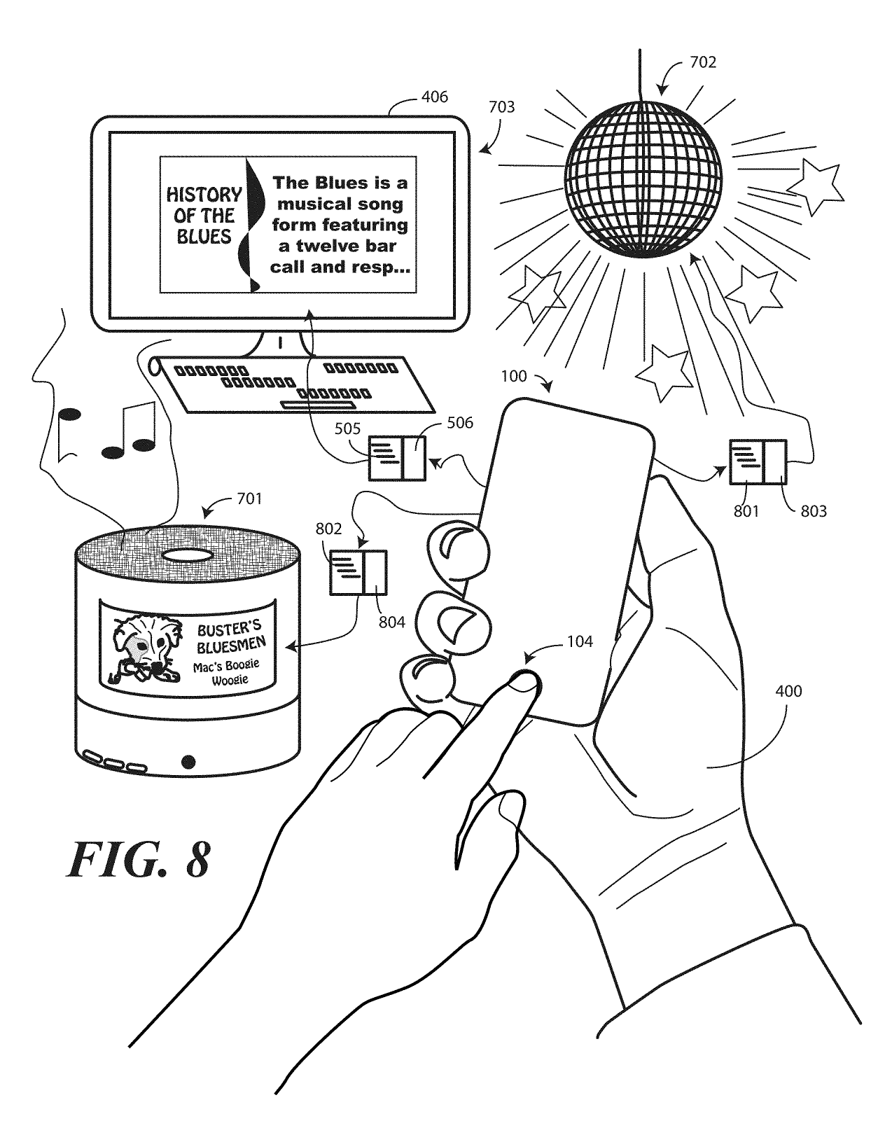

As noted above in the description of FIG. 3, in some embodiments when multiple companion devices or authentication agents are identified, no selection occurs. To the contrary, authentication credentials can simply be transmitted to all companion devices. Such is the case in FIG. 8.

Turning now to FIG. 8, since the electronic device 100 has identified a plurality of authentication agents operating on one or more companion devices 701, 702, 703 operating within the wireless communication radius of the electronic device 100, it selects an authentication credential 505, 801, 802 for each authentication agent and causes the wireless communication circuit (109) to deliver all selected authentication credentials 505, 801, 802 to all authentication agents operating on all companion devices 701, 702, 703. In this illustrative embodiment, the wireless communication circuit (109) delivers all selected authentication credentials 505, 801, 802, with corresponding authentication tools 506, 803, 804 contemporaneously.

This causes several things to occur. The authentication credential 802 delivered to the first companion device 701 causes the music streaming service to start streaming music. Accordingly, the music player actuates and starts playing “Mac's Boogie Woogie” by the infamous Buster and his Bluesmen. The delivery of authentication credential 801 to the first companion device 701 actuates the disco strobe light so that a club-type atmosphere is invoked to enhance the joy that the catalog of Buster and his Bluesmen.

In this illustrative embodiment, the context engine (124) of the electronic device 100 has included two authentication credentials in the communication to the computer 406. A first is for the authentication agent (407) of the computer, and a second is for a local library portal where education can be received. Accordingly, the authentication credential 505 both unlocks the computer and logs into the library portal. As the context engine (124) determines that the streaming music is indeed boogie woogie, which has a form based in twelve-bar blues, the authentication tool 506 transmitted with the authentication agent 407 not only accesses the computer 406 and library access portal, but causes a brief history of the blues to be presented on the display. Accordingly, the user 400 can learn, while listening, and dancing beneath the strobe light, all from a simple touch of the fingerprint sensor 104 of the electronic device 100.

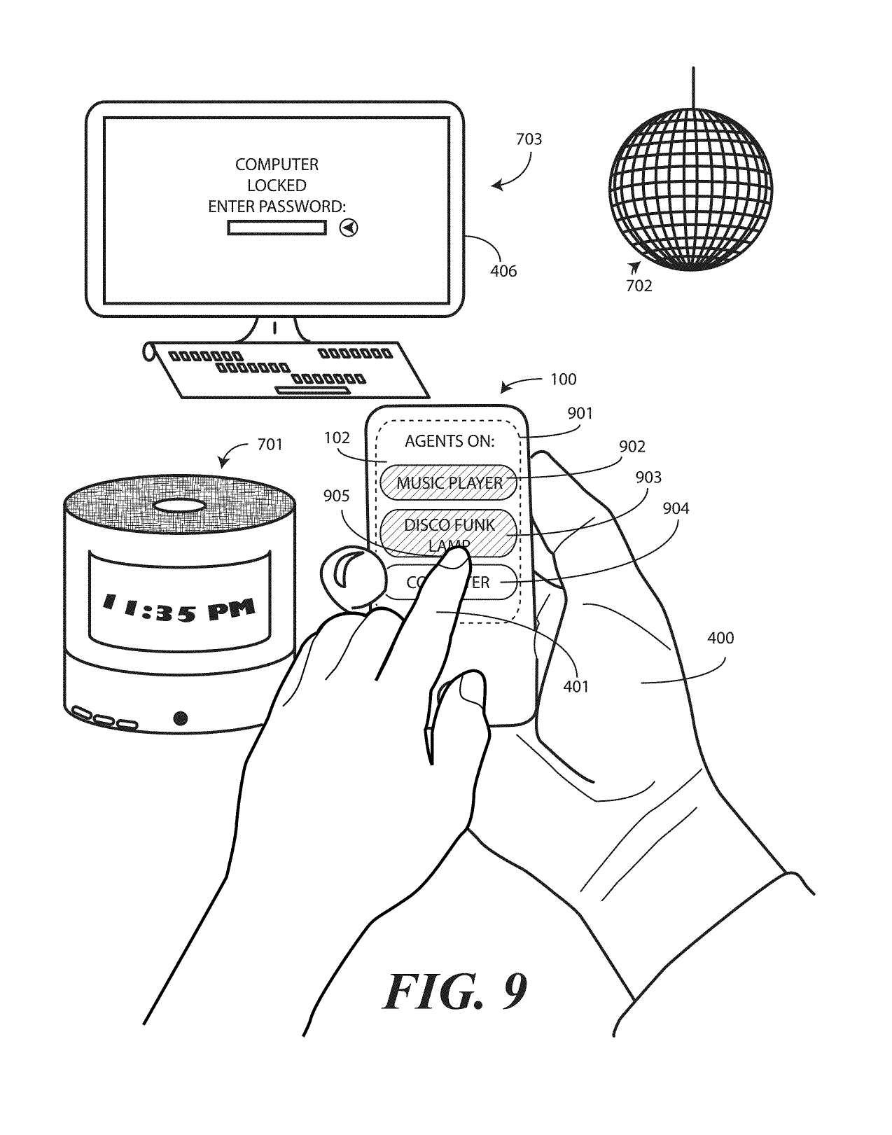

In other embodiments, the user 400 will want authentication credentials delivered to only some devices. Accordingly, they will prefer to select which devices receive authentication credentials. The electronic device 100 can identify a user selection in a variety of ways. A list of the companion devices 701, 702 could be presented on the display from which the user 600 could make a selection by touch. Alternatively, an audible list of the companion devices 701, 702 could be delivered through a loudspeaker, with the user 600 making a choice with a voice command. FIGS. 9-14 describe below illustrate various ways selections can be made.

Turning now to FIG. 9, illustrated therein is one way this can occur. After the user 400 places their finger 401 on a fingerprint sensor 104 of an electronic device 100, and after the fingerprint sensor 104 identifies fingerprint data from the user's finger 401 to authenticate the user 400, the electronic device 100 once again identifies the first companion device 701, the second companion device 702, and the third companion device 703 operating within the predefined communication radius. Additionally, the electronic device 100 identifies the authentication agent operating on each companion device.

Rather than sending authentication credentials to all authentication agents, in one the electronic device 100 then presents indicia 901 identifying the authentication agents on the user interface of the electronic device 100. In this illustrative embodiment, the indicia 901 is a textual listing of the various authentication agents 902, 903, 904 presented on the display 102 of the electronic device 100. The user 400 is then able to make a user selection 905 of one or more of the authentication agents 902, 903, 904 by touching user actuation targets. In this illustration, the user 400 has selected authentication agents 902, 903 operating both the music player and the disco strobe light because he wants to listen to music in a club-like atmosphere, but does not need the computer 406.

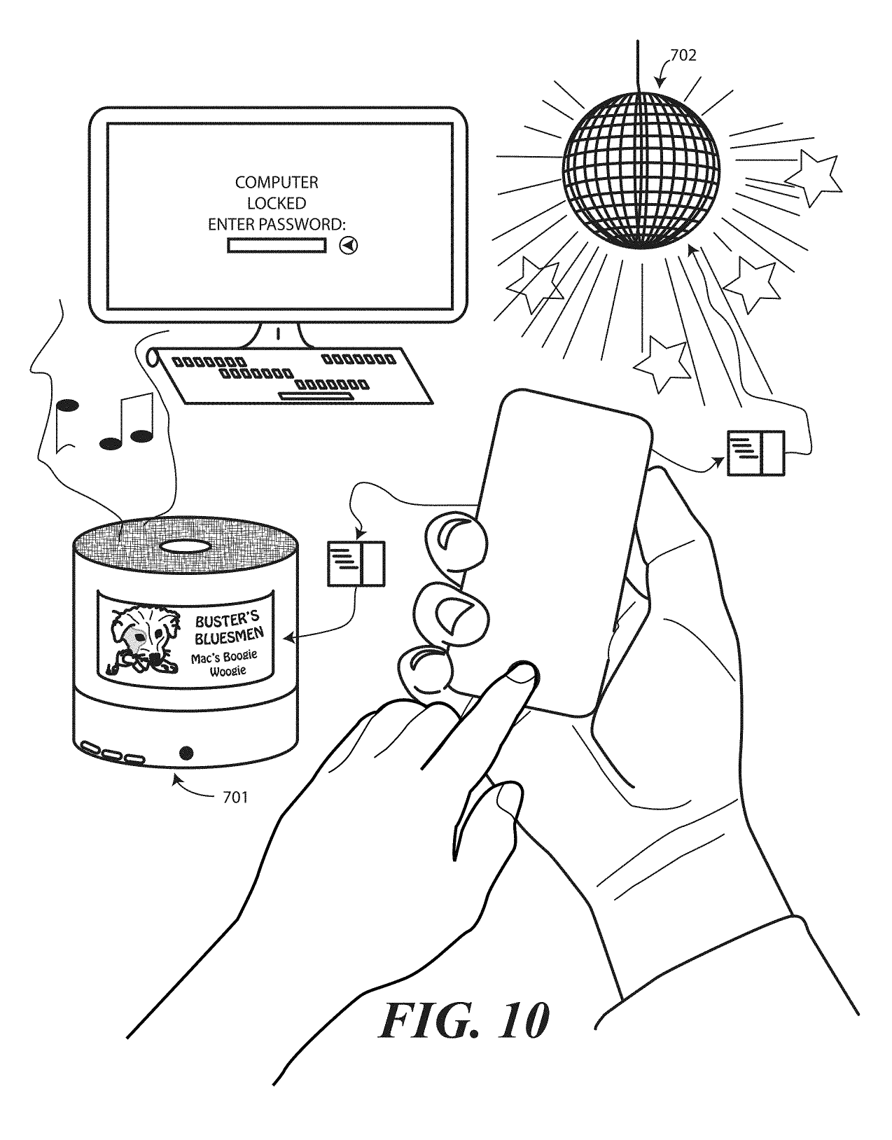

This causes the wireless communication circuit (109) operating in the electronic device 100, which is responsive to the auxiliary processor (108) or the application processor (107), to deliver an authentication credential to two authentication agents 902, 903 operating on two companion devices 701, 702. As shown in FIG. 10, this causes the first companion device 701 to play “Mac's Boogie Woogie,” while the second companion device 702 illuminates so that a club-type atmosphere is invoked to enhance the joy that the catalog of Buster and his Bluesmen.

Turning now to FIG. 11, illustrated therein is another selection technique, this time using the context engine (124) of the electronic device 100. After the user 400 places their finger 401 on a fingerprint sensor 104 of an electronic device 100, and after the fingerprint sensor 104 identifies fingerprint data from the user's finger 401 to authenticate the user 400, the electronic device 100 once again identifies the first companion device 701, the second companion device 702, and the third companion device 703 operating within the predefined communication radius. Additionally, the electronic device 100 identifies the authentication agent operating on each companion device.

In this embodiment, the context engine (124) is operating on the electronic device 100. The context engine (124) is operable to detect a contextual operating condition 1101 of the electronic device 100 and select at least one authentication agent operating on the at least one companion device from the contextual operating condition 1101. In this example, the contextual operating condition 1101 is that of the electronic device 100 operating in a screen-sharing mode. Thus, the authentication agent 407 of the third companion device 703 is being presented on the display 102 of the electronic device 100. Accordingly, in one embodiment the context engine (124) detects this contextual operating condition 1101. Since the authentication agent 407 of the third companion device 703 is being presented on the display 102 of the electronic device 100, the context engine (124) can conclude that the authentication credential for this authentication agent 407 should be delivered. Accordingly, despite there being three companion devices 701, 702, 703 operating within the wireless communication radius, the context engine (124) selects the authentication agent 407 operating on the third companion device 703.

Turning now to FIG. 12, upon the context engine (124) selecting the authentication agent (407), the electronic device 100 selects an authentication credential 505 for the authentication agent 407. In this embodiment, the auxiliary processor (108) or application processor (107) additionally selects an actuation tool 506 as well. The wireless communication circuit (109) of the electronic device 100 then delivers (508) the authentication credential 505 and authentication tool 506 to the authentication agent 407 of the third companion device 703. The actuation tool 506 then loads the authentication credential 505 into the authentication agent 407 as previously described.

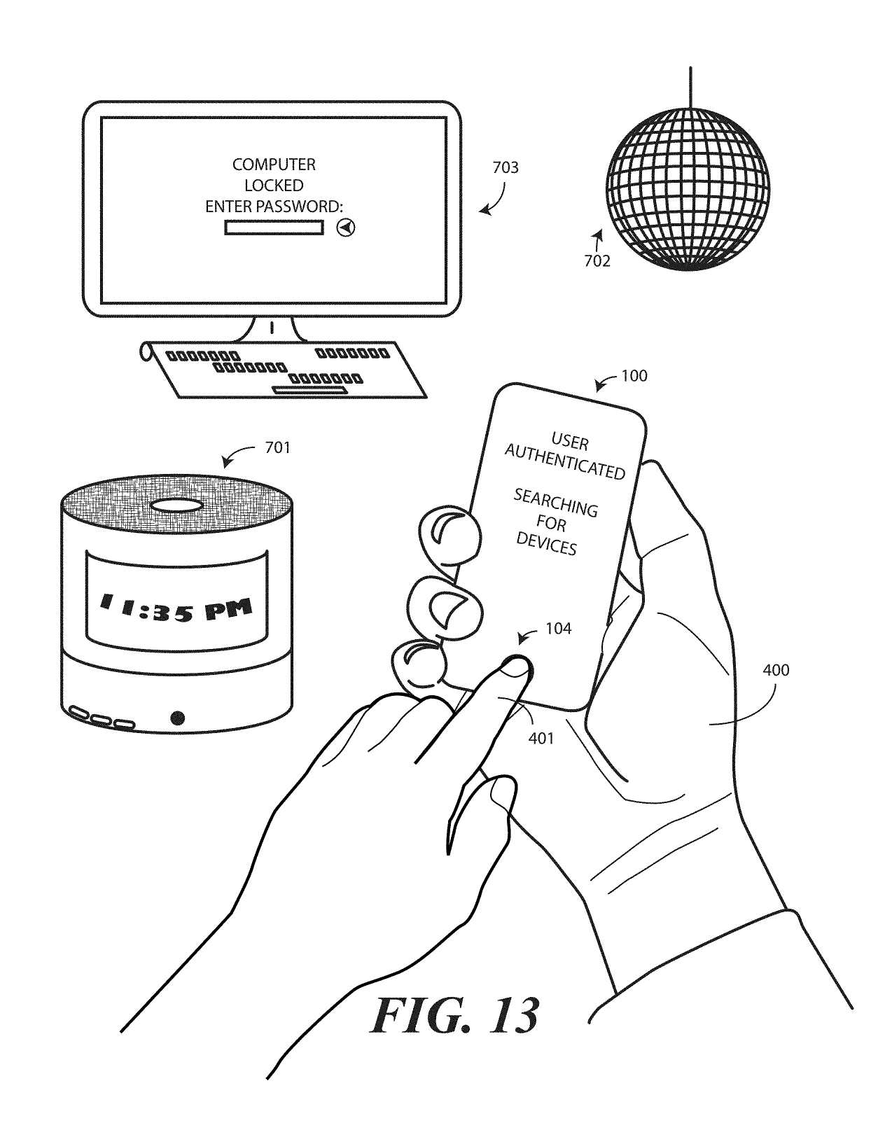

Turning now to FIG. 13, illustrated therein is another selection technique, this time using electronic communications received by the electronic device 100. After the user 400 places their finger 401 on a fingerprint sensor 104 of an electronic device 100, and after the fingerprint sensor 104 identifies fingerprint data from the user's finger 401 to authenticate the user 400, the electronic device 100 once again identifies the first companion device 701, the second companion device 702, and the third companion device 703 operating within the predefined communication radius. Additionally, the electronic device 100 identifies the authentication agent operating on each companion device.

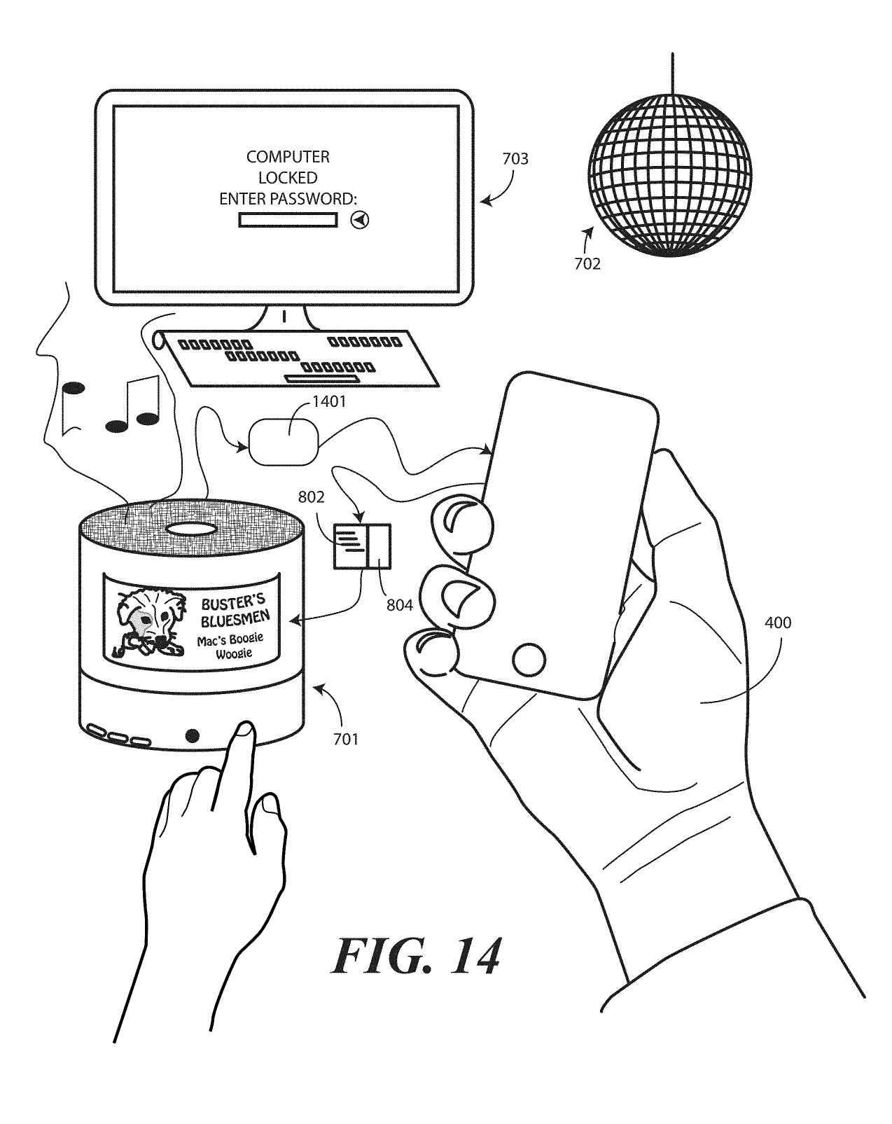

In this embodiment, the selection of which authentication agent is to receive the authentication credential is made by electronic communications. Turning to FIG. 14, the user 400 touches the first companion device 701. This causes the first companion device 701 to send an electronic communication 1401 to the electronic device. Accordingly, despite there being three companion devices 701, 702, 703 operating within the wireless communication radius, the electronic communication 1401 identifies the authentication agent operating on the first companion device 701. The electronic device 100 then selects an authentication credential 802 for the authentication agent, and optionally an actuation tool 804 as well. The wireless communication circuit (109) of the electronic device 100 then delivers the authentication credential 802 and authentication tool 804 to the authentication agent of the first companion device 701. Buster and his Bluesmen then start swinging.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a biometric sensor identifying a biometric input received at the biometric sensor;
one or more processors operable with the biometric sensor, the one or more processors:
identifying at least one authentication agent operating on at least one companion device operating within a wireless communication radius of the electronic device; and
in response to the biometric sensor identifying the biometric input, selecting at least one authentication credential for the at least one authentication agent; and
a wireless communication circuit responsive to the one or more processors, the wireless communication circuit delivering an authentication credential to the at least one authentication agent of the at least one companion device.

2. The electronic device of claim 1, the biometric sensor comprising a fingerprint sensor, the biometric input comprising fingerprint data.

3. The electronic device of claim 2, the one or more processors selecting the at least one authentication credential from an authentication credential store storing a plurality of authentication credentials.

4. The electronic device of claim 1, the one or more processors further:
identifying a plurality of authentication agents operating on one or more companion devices operating within the wireless communication radius of the electronic device;
selecting the authentication credential for each authentication agent; and
causing the wireless communication circuit to deliver all selected authentication credentials to authentication agents operating on the one or more companion devices.

5. The electronic device of claim 4, the wireless communication circuit delivering the all selected authentication credentials contemporaneously.

6. The electronic device of claim 1, further comprising a user interface, the one or more processors further:
identifying a plurality of authentication agents operating on one or more companion devices operating within the wireless communication radius of the electronic device;
presenting, on the user interface, indicia identifying at least some of the plurality of authentication agents; and
receiving, from the user interface, a selection of one or more authentication agents.

7. The electronic device of claim 6, further comprising:
selecting the authentication credential for each authentication agent in the selection of one or more authentication agents; and
causing the wireless communication circuit to deliver the authentication credential to the selection of one or more authentication agents.

8. The electronic device of claim 1, the one or more processors further:
identifying a plurality of authentication agents operating on one or more companion devices operating within the wireless communication radius of the electronic device; and
receiving, with the wireless communication circuit, an electronic communication comprising a selection of the at least one authentication agent from the at least one companion device.

9. The electronic device of claim 1, further comprising a context engine operable with the one or more processors, the context engine:
detecting a contextual operating condition of the electronic device; and
identifying the at least one authentication agent operating on the at least one companion device from the contextual operating condition.

10. The electronic device of claim 1, the one or more processors further:
selecting at least one actuation tool operable with the at least one authentication agent for ingestion of the at least one authentication credential; and
causing the wireless communication circuit to transmit the at least one actuation tool with the at least one authentication credential.

11. The electronic device of claim 1, further comprising a user interface operable with the one or more processors, the one or more processors providing a notification with the user interface that the authentication credential was delivered by the wireless communication circuit.

12. The electronic device of claim 1, the authentication credential unlocking the at least one companion device.

13. The electronic device of claim 1, the authentication credential comprising one or more of a user name or a password.

14. The electronic device of claim 1, the at least one companion device comprising a paired companion device.

15. The electronic device of claim 1, the one or more processors comprising an application processor and an auxiliary processor, the auxiliary processor:
identifying the at least one authentication agent operating on the at least one companion device; and
selecting the at least one authentication credential for the at least one authentication agent.

16. A method, comprising:
receiving, with a biometric sensor of a first electronic device, a biometric input;
authenticating, with one or more processors operable with the biometric sensor, the biometric input;
identifying, with the one or more processors, at least one authentication agent operating on at least a second electronic device operating within a wireless communication radius of the first electronic device;
selecting, with the one or more processors, at least one authentication credential for the at least one authentication agent; and
transmitting, with a wireless communication circuit operable with the one or more processors, the at least one authentication credential to the at least one authentication agent of the at least the second electronic device.

17. The method of claim 16, the identifying comprising identifying a plurality of authentication agents, the method further comprising receiving, with a user interface operable with the one or more processors, a selection of the at least one authentication agent.

18. The method of claim 16, the identifying comprising identifying a plurality of authentication agents, the selecting comprising selecting a plurality of authentication credentials corresponding to the plurality of authentication agents, the transmitting comprising transmitting the plurality of authentication credentials.

19. The method of claim 16, the identifying comprising identifying a plurality of authentication agents, further comprising receiving, with the wireless communication circuit, an electronic communication identifying a selection of the at least one authentication agent.

20. The method of claim 16, further comprising determining a contextual operating condition of the first electronic device, wherein the selecting is a function of the contextual operating condition.
